(19) United States
(12) Patent Application Publication
(10) Pub. No.: US 2007/0188763 A1
(43) Pub. Date: Aug. 16, 2007

(54) Turbidity sensor

(76) Inventor: Johann Schenkl, Pingarten (DE)

Correspondence Address: STRAUB & POKOTYLO, 620 TINTON AVENUE, BLDG. B, 2ND FLOOR, TINTON FALLS, NJ, 07724, US

(21) Appl. No.: 10/582,905

(22) PCT Filed: Dec. 15, 2004
(86) PCT No.: PCT/EP04/14301

§ 371 Date: Jun. 13, 2006

(30) Foreign Application Priority Data
Dec. 15, 2003 (DE) 10358647.4

(51) Int. Cl. G01N 21/00

(52) U.S. Cl. 356/436

(57) ABSTRACT

Sensor for transmission measurement in a washing machine or dishwasher, with a carrier (2) a transmitter (4) attached to the carrier (2) to emit a transmitter beam, a receiver (6) attached to the carrier (2) to receive the beam generated by the transmitter (4), and a diaphragm system arranged on the carrier spaced from the transmitter and/or receiver.

### AREA OF THE INVENTION

The present invention concerns a sensor to measure the transmission of a fluid used in a washing machine or dishwasher and a method for production of such a sensor.

### BACKGROUND OF THE INVENTION

Sensors to detect the clouding of a fluid used in a washing machine or dishwasher are well known. Such sensors comprise a transmitter which emits a measurement beam through a fluid, the transmission of which is to be determined, and a receiver in order to receive the beam based on the measurement beam after passage through the fluid. Comparison of the measurement beam emitted by the transmitter and the beam received by the receiver allows determination of the fluid transmission.

The transmission determined by means of such a sensor may deviate from the actual fluid transmission for several reasons. On its propagation path through the fluid the measurement beam from the transmitter is subject to scatter. Scattered parts of the measurement beam however for example because of multiple scatter can reach the receiver. As a result the receiver can receive a proportion of the measurement beam which is higher than the beam proportion which gives the actual transmission.

To reduce scatter effects it is known to use transmitters which emit the measurement beam with a beam path which has a small cross section in the propagation direction. For this for example transmitters generating laser beams are suitable. The transmitters required are however expensive. Furthermore transmitters with such a beam path must be aligned very precisely in relation to the receiver in order to achieve the desired effect on the receiver side.

Furthermore it is known to arrange lenses on both the transmitter side and the receiver side to bundle the beam generated by the transmitter and restrict the reception characteristic of the receiver to the beam arriving from the direction of the transmitter. In view of the small dimensions of such sensors, the use of lenses requires precisely produced lenses and costly production processes to arrange the lenses correctly.

In order firstly to be able to use simple economic transmitters and receivers and secondly to achieve matched emission and reception characteristics, it is known to use a common holder for the transmitter and receiver or separate holders for the transmitter and receiver. In both cases a desired spatial alignment of the transmitter and receiver relative to each other is achieved, for example where corresponding holders are used for the transmitter and receiver which hold these in the desired positions. To prevent disruptive external areas, in particular secondary lobes of the beam generated by the transmitter, being able to propagate through a fluid to be measured and reach the receiver, holders can be used which on the transmitter side have a diaphragm integrated into the construction unit. The diaphragm on the transmitter side is formed to the holders such that it allows passage of the main lobe of the transmitter beam. To prevent scattered beams reaching the receiver, a holder can be used which on the receiver side also integrates a further diaphragm in the construction unit. This diaphragm too is formed on the holder so that the reception characteristic of the receiver is fully utilised in the area of the main lobe while peripheral reception areas are shadowed.

On use of one or more holders for the transmitter and receiver the measures necessary to wire the transmitter and receiver are performed after the transmitter and receiver are fixed in the corresponding holders. This procedure complicates the production process in particular when the transmitter and receiver are to be connected on a circuit board using SMD technology.

### OBJECT OF THE INVENTION

The object of the invention is to provide a sensor to detect the transmission of a fluid used in a washing machine or dishwasher, which can be produced in a simple and economic manner, in particular requires no selected transmitter and receiver and allows a precise transmission measurement.

### BRIEF DESCRIPTION OF THE INVENTION

To achieve this object the invention proposes sensors which are suitable for measuring the transmission of a fluid used in a washing machine or dishwasher.

The sensor according to claim 1 has a carrier, a transmitter attached to the carrier and serving to emit a transmitter beam, a receiver attached to the carrier and serving to receive the beam generated by the transmitter, and a diaphragm system. The diaphragm system is arranged on the carrier spaced from the transmitter. This means in particular that the diaphragm system has no function connected with the arrangement, alignment and fixing of the transmitter to the carrier or receiver. The diaphragm system has a transmitter diaphragm arranged in the beam path of the transmission beam. By means of the transmitter diaphragm, on the basis of the transmitter beam a measurement beam is generated that is aligned to the receiver.

The arrangement of the diaphragm system independent of the transmitter allows the use of a carrier (e.g. a circuit board suitable for SMD technology) on which the transmitter is attached pre-assembled for example in SMD technology. Furthermore the separate construction of the diaphragm system avoids the procedure, necessary in the prior art, of precisely aligning the transmitter relative to the receiver. Rather in this sensor according to the invention it is merely necessary to align the sensor roughly to the receiver. The actual alignment in relation to the receiver does not take place by the arrangement of the transmitter but by the transmitter diaphragm which generates the aligned measurement beam from the transmitter beam i.e. the beam from the transmitter.

In particular it is proposed to use a transmitter, the emission characteristic of which in the area of the main lobe have such a large aperture angle that the transmission diaphragm screens the transmitter beam in the area of the main lobe. Such a transmitter simplifies the construction of the sensor according to the invention because the transmitter need merely be attached pre-assembled to the carrier so that at least part of the beam of the main lobe of the transmitter would reach the receiver if no diaphragm or similar were arranged between the transmitter and receiver.

In this sensor according to the invention the parts of the measurement beam which reach the receiver are used to measure the transmission.

For this the reception characteristic of the receiver is utilised substantially unchanged in order to receive the measurement beam and from this derive a transmission. Preferably a transmitter of high power is used to achieve a ratio of the parts of the measurement beam which reach the receiver without scatter and the parts of the measurement beam which reach the receiver after scatter, that minimises the effects of scatter on the measurement results.

The sensor according to claim 2 has a carrier, a transmitter attached to the carrier and serving to emit a transmitter beam, a receiver attached to the carrier and serving to receive the beam generated by the transmitter and a diaphragm system. The diaphragm system is arranged on the carrier spaced from the receiver. This means in particular that the diaphragm system has no function connected with the arrangement, alignment and fixing of the receiver to the carrier or the transmitter. The diaphragm system has a receiver diaphragm which is arranged in the beam path of the transmitter beam. By means of the receiver diaphragm, on the basis of the beam from the transmitter a reception beam aligned to the receiver is generated.

The arrangement of the diaphragm system independent of the receiver allows the use of a carrier (e.g. a circuit board suitable for SMD technology) on which the receiver is attached pre-assembled for example in SMD technology. Furthermore by separate construction of the diaphragm system the procedure, necessary in the prior art, of arranging the receiver precisely aligned to the transmitter is omitted. Rather in this sensor according to the invention it is merely necessary to align the receiver roughly to the transmitter. The actual alignment of the receiver to the transmitter does not take place by arrangement of the receiver but by the receiver diaphragm which generates the aligned reception beam from the transmitter beam i.e. the beam from the transmitter.

In particular it is proposed to use a receiver, the emission characteristic of which in the area of the main lobe has such a large aperture angle that the receiver diaphragm restricts the reception characteristic of the receiver to an area or parts within the main lobe.

In this sensor according to the invention the parts of the transmitter beam which penetrate through the receiver diaphragm and reach the receiver are used to measure the transmission.

The sensor according to claim 3 has a carrier, a transmitter attached to the carrier and serving to emit a transmitter beam, a receiver attached to the carrier and serving to receive the beam generated by the transmitter, and a diaphragm system. The diaphragm system is arranged on the carrier spaced from the transmitter and spaced from the receiver. This means in particular that the diaphragm system has neither any function connected with the arrangement, alignment and fixing of the transmitter to the carrier or the receiver, nor any function connected with the arrangement, alignment and attachment of the receiver to the carrier or the transmitter. The diaphragm system has a transmitter diaphragm arranged in the beam path of the transmitter beam. By means of the transmitter diaphragm, on the basis of the transmitter beam the measurement beam aligned to the receiver is generated. Furthermore the diaphragm system has a receiver diaphragm arranged in the beam path of the measurement beam. By means of the receiver diaphragm, on the basis of the measurement beam a reception beam aligned to the receiver is generated.

In the sensor according to the invention the statements above in relation to the independent arrangement and separate construction of the diaphragm system with regard to transmitter and receiver and in relation to the emission characteristic of the transmitter and the reception characteristic of the receiver apply accordingly.

In this sensor according to the invention the parts of the measurement beam which penetrate through the receiver diaphragm and reach the receiver are used to measure the transmission.

This achieves that substantially the only parts of the measurement beam which reach the receiver are those that are propagated in a straight line from the transmitter without scatter through the transmitter diaphragm and the receiver diaphragm to the receiver. This achieves an alignment of the transmitter beam used for measurement to the receiver. This allows use of a receiver whose reception characteristic has a large aperture angle (e.g. more than 60°) which without use of the receiver diaphragm would also receive parts of the measurement beam which reach the receiver after scatter, so that faulty transmission measurements could be generated. The procedure according to the invention in contrast makes it possible to use even such “poor” receivers without running the risk that transmission measurements would not give the actual transmission because of scatter effects.

The common factor in the sensors according to the invention is an alignment of the beam used for measuring the transmission in relation to the receiver. In the prior art alignment of the transmitter and receiver was achieved by a corresponding arrangement thereof relative to each other. The associated costly production processes are avoided by the present invention. In addition to the known constructional alignment of transmitters and receivers, in the prior art sensors are used which have a small aperture angle in the area of the main lobe of their emission characteristic and advantageously have small side lobes, and receivers which have a reception characteristic with a main lobe of small aperture angle. Such transmitters and receivers are costly and compared with transmitters and receivers whose main lobes have large aperture angles must be aligned precisely to each other with even greater expense. Also the use of such transmitters and receivers is avoided by the present invention. Rather in sensors according to the invention “poor” transmitters and receivers are used which in addition need not be aligned precisely relative to each other.

It is further provided that the sensor has a further transmitter which is attached to the circuit board also spaced from the diaphragm system and emits a further transmitter beam.

Use of the further transmitter allows the achievement of measurement sections of different lengths in relation to transmitter and further transmitter, the specification of different measurement directions and the use of transmitter beams of different wavelength and/or power.

When the transmitter is used with a transmitter diaphragm, the further transmitter and receiver without receiver diaphragm, parts of the measurement beam i.e. the transmitter beam after passage through the transmitter diaphragm, and parts of the further transmitter beam which reach the receiver, are used for transmission measurement.

The receiver can receive beams comprising two parts. Namely one part which is subject to low scatter on its propagation path through the fluid (i.e. parts of the measurement beam aligned to the receiver which reach the receiver) and a part which compared with the other part is subject to greater scatter (i.e. parts of the further transmitter beam not aligned to the receiver which reach the receiver).

In order to be able to distinguish between the beam parts reaching the receiver, it is proposed to use the transmitter and further transmitter intermittently, alternately and/or to use transmitters of different wavelength and/or power.

On use of the transmitter without transmitter diaphragm, the further transmitter and receiver with receiver diaphragm, the parts of the transmitter beam and the parts of the further transmitter beam which reach the receiver are used for transmission measurement.

In particular in this embodiment it is proposed to use the transmitter and further transmitter intermittently, alternately, and/or use transmitters which emit beams of different wavelength and/or power.

On use of the transmitter with transmitter diaphragm, the further transmitter and receiver with receiver diaphragm, the parts of the measurement beam i.e. the transmitter beam after passage through the transmitter diaphragm and parts of the further transmitter beam which penetrate through the receiver diaphragm and reach the receiver, are used for transmission-measurement.

The receiver can thus receive beams which comprise two parts. Namely one part which is subject to little scatter on its propagation path through the fluid (i.e. parts of the measurement beam aligned to the receiver) and a part which compared with the other part is subject to greater scatter (i.e. parts of the further transmitter beam not aligned to the receiver). The receiver diaphragm achieves substantially that the only parts of the measurement beam from the transmitter and parts of the further transmitter beam from the further transmitter that reach the receiver are those which propagate from the transmitter or further transmitter without scatter in a straight line in the direction of the receiver. This achieves that the parts of scattered beams which can reach the receiver without use of the receiver diaphragm are at least minimised.

It is further provided to also use a transmitter diaphragm for the further transmitter in order to generate from the further transmitter beam a further measurement beam aligned to the receiver. For this the diaphragm system has a further transmitter diaphragm which is arranged in the beam path of the further transmitter beam.

The above statements in relation to embodiments in which the transmitter is used with transmitter diaphragm and the receiver without receiver diaphragm, the transmitter without transmitter diaphragm and the receiver with receiver diaphragm, and the transmitter with transmitter diaphragm and the receiver with receiver diaphragm, also apply correspondingly to the latter embodiment where instead of the further transmitter beam, the further measurement beam is used.

In a further preferred embodiment the sensor has a further receiver which is attached to the carrier also spaced from the diaphragm system.

In embodiments in which the transmitter is used with transmitter diaphragm, parts of the measurement beam reach the further receiver which are reflected and/or scattered on propagation of the measurement beam through the fluid and consequently do not reach the receiver. On the basis of the beam received by the further receiver, by means of the receiver to which the measurement beam is aligned, the transmission measurements obtained are corrected in particular with regard to scatter and/or reflection effects. Furthermore the further receiver can be used to make additional statements on the properties of the fluid such as e.g. on the solids particles and foam contained in the fluid.

This also applies to embodiments in which the transmitter is used without transmitter diaphragm and the receiver with receiver diaphragm, where the alignment is achieved on the receiver side.

In embodiments in which two transmitters and two receivers are used, the above statements with regard to the receiver also apply to the further receiver. When two transmitters and one receiver are used, two measurement sections can be implemented namely a first measurement section between the transmitter and receiver and a second measurement section between the further transmitter and receiver.

When two transmitters and two receivers are used, up to four measurement sections can be implemented namely a first measurement section between the transmitter and receiver, a second measurement section between the further transmitter and the further receiver, a third measurement section between the transmitter and further receiver and fourth measurement section between the further transmitter and the further receiver.

Preferably in embodiments in which the further receiver is present, the diaphragm system is arranged on the carrier so that is spaced from the further receiver and has a further receiver diaphragm. Here too the diaphragm system has no function connected with the arrangement, alignment and fixing of the further receiver on the carrier or in relation to the transmitter and/or further transmitter. The above statements in relation to the receiver with receiver diaphragm apply accordingly to the further receiver.

Preferably the carrier for example a circuit board has a first leg and a second leg which extend substantially parallel to each other from a common base. Here the transmitter is arranged on the first leg and the receiver on the second leg opposite the transmitter. Use of such a carrier allows the construction of the sensor in a form in which transmission of a fluid can be measured which lies between the legs of the carrier.

On use of the further transmitter and/or further receiver, it is proposed that the further transmitter is attached to the first leg and the further receiver to the second leg or conversely. Here it is possible to arrange the transmitters and/or receivers each on a common surface of a leg or on different surfaces of a leg.

On use of a carrier with legs, it is further provided that the diaphragm system also has a first leg and a second leg. Preferably the diaphragm system is formed so that its first leg is arranged on the first leg of the carrier and its second leg on the second leg of the carrier. The transmitter diaphragm(s) and/or receiver diaphragm(s) are then formed corresponding to the arrangement of the transmitter(s) or receiver(s) on the first and second legs of the diaphragm system.

Furthermore the present invention to achieve the above object proposes a method for producing a sensor which serves to measure the transmission of a fluid in a washing machine or dishwasher and comprises a carrier, a first transmitter, a first receiver and a diaphragm system.

A transmitter is used which serves to emit a transmitter beam. A receiver is provided which serves to receive a reception beam. Preferably as carrier a circuit board is used which serves for electrical connection and/or control of the transmitter and receiver.

In all methods according to the invention, first the transmitter and receiver are attached to the carrier. This can be achieved for example by soldering. Then the diaphragm system is arranged on the carrier.

In a method according to the invention, the diaphragm system is arranged on the carrier so that it is spaced from the transmitter. This applies in particular to a transmitter diaphragm held by the diaphragm system and arranged in the beam path of the transmitter beam in order to generate on the basis of the transmitter beam a measurement beam aligned to the receiver.

In a further method according to the invention the diaphragm system is arranged on the carrier so that it is spaced from the receiver. This applies in particular to a receiver diaphragm held by the diaphragm system and arranged in the beam path of the transmitter beam in order to generate on the basis of the transmitter beam a reception beam aligned to the receiver.

In a further method according to the invention the diaphragm system is arranged on the carrier so that it is spaced from both the transmitter and from the receiver.

This applies in particular to a transmitter diaphragm held by the diaphragm system and a receiver diaphragm held by the diaphragm system. The transmitter diaphragm is arranged in the beam path of the transmitter beam to generate a measurement beam. The receiver diaphragm is arranged in the beam path of the measurement beam in order to generate a reception beam aligned to the receiver from the parts of the measurement beam which reach the receiver diaphragm.

In order to construct one of the embodiments described above of the sensor according to the invention in which a further transmitter and/or further receiver are provided, the further transmitter or further receiver are also attached to the carrier before the diaphragm system, which can comprise a further transmitter diaphragm and/or a further receiver diaphragm, is arranged on the carrier.

### BRIEF DESCRIPTION OF THE FIGURES

In the description below of preferred embodiments, reference is made to the enclosed diagrams which show:

FIG. 1: a diagrammatic depiction of a sensor according to the invention,

FIGS. 2, 3 and 4: diagrammatic depictions of a preferred embodiment of the sensor according to the invention

### DESCRIPTION OF PREFERRED EMBODIMENTS

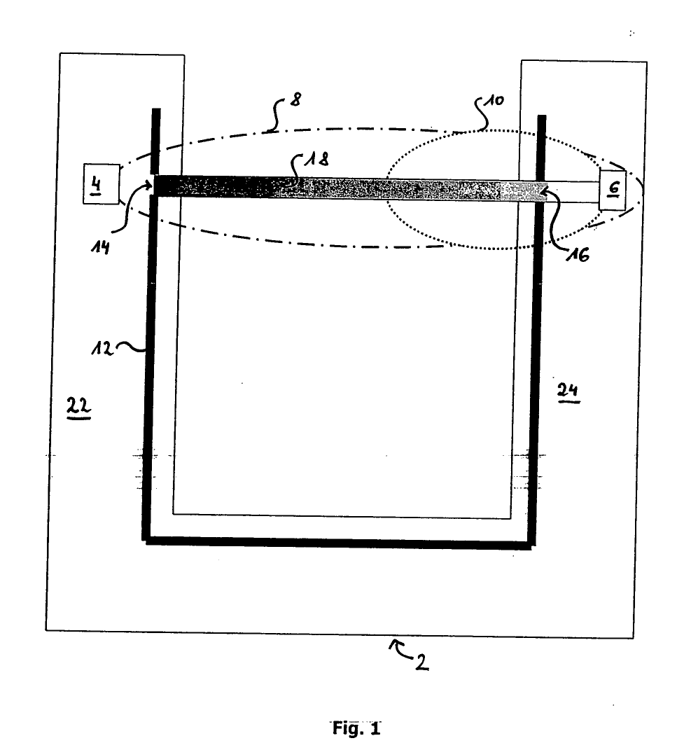

The simplified view of a sensor according to the invention in FIG. 1 shows a carrier 2 on which are attached a transmitter 4 and a receiver 6. As a carrier 2 is preferably provided a circuit board designed for SMD technology. As transmitter 4 and receiver 6 are provided optical components to provide an optical measurement section. For example as a transmitter 4 an LED can be used while as a receiver 6 a photo transistor, a photo diode or a solar cell can be used.

The transmitter 4 has an emission characteristic indicated by the dashed outline 8. The receiver 6 has a reception characteristic indicated by the dashed outline 10. The emission characteristic 8 and reception characteristic 10 show for the sake of simplicity only the transmitter and receiver main lobes of the transmitter 4 and receiver 6; secondary lobes of both the transmitter 4 and receiver 6 are not shown.

Also arranged on the carrier 2 is a diaphragm system 12 which is spaced both from the transmitter 4 and from the receiver 6 and attached as a separate component to the carrier 2. The diaphragm system 12 has a transmitter diaphragm 14 and a receiver diaphragm 16. The transmitter diaphragm 14 is arranged in the beam path of the beam generated by the transmitter 4.

Part of the beam from the transmitter 4 in the area of the main lobe of the emission characteristic 8 can pass through the transmitter diaphragm 14 and propagate in the direction towards the receiver 6. The part of the beam from the transmitter 4 penetrating through the transmitter diaphragm 14 defines a measurement beam 18 with which the transmission can be measured of a fluid 20 located between legs 22 and 24 of the carrier 2.

The transmitter diaphragm 14 in contrast to the prior art not only screens secondary lobes of the emission characteristic of transmitter 4 but also areas of the main lobe. Therefore in contrast to the prior art it is not necessary to attach the transmitter 4 to the carrier 2 so that it is optimally aligned in relation to receiver 6. Furthermore it is sufficient to position the transmitter 4 so that its emission characteristic 8 (main lobe) comprises an area in which the transmitter diaphragm 14 is present. The alignment in relation to the receiver 6 is achieved by the transmitter diaphragm 14 which only allows passage of the parts of the beam of the main lobe which propagate in the direction towards the receiver 6. In other words the transmitter diaphragm 14 generates a measurement beam aligned to the receiver 6. This allows the use of an economic transmitter as transmitter 4, the emission characteristic of which, in particular because of too large an aperture angle and the resulting scatter effect, is not suitable for allowing reliable measurement of the transmission of fluid 20.

The transmitter diaphragm 14 and receiver diaphragm 16 are formed opposite each other in the diaphragm system 12. The measurement beam 18 propagates starting from the transmitter diaphragm 14 through the fluid 20 to the receiver diaphragm 16 and passes through this. Depending on the transmission of fluid 20, the power of the measurement beam 18 in the region of the receiver diaphragm 16 is reduced in relation to the power in the region of the transmitter diaphragm 14. This is indicated in FIG. 1 by the shadowing of the measurement beam 18.

The parts of the measurement beam 18 which penetrate through the receiver diaphragm 16 are received by the receiver 6 and used to determine the transmission of fluid 20. The receiver diaphragm 16 prevents, on propagation through the fluid 20, scattered parts (not shown) of the measurement beam 18 from reaching the receiver 6. Without the receiver diaphragm 16 the receiver 6 would receive all parts of the measurement beam 18 which fall in the region indicated by the reception characteristic 10. Without the receiver diaphragm 16, measurements by means of the receiver 6 would be falsified in particular due to scatter effects which occur on propagation of the measurement beam 18 through the fluid 20.

The receiver diaphragm 16 in contrast to the prior art not only screens the secondary lobes of the receiver 6 but also areas of the main lobe of the receiver 6 which lie outside the idealised propagation path of the measurement beam 18 shown in FIG. 1. The receiver diaphragm 16 as a result achieves an alignment of the reception characteristic of receiver 6 to the measurement beam 18 or transmitter diaphragm 14 which can be regarded as a virtual measurement beam source. Because of the receiver diaphragm 16, in contrast to the prior art it is not necessary to align the receiver 6 precisely to the transmitter 4 or transmitter diaphragm 14. Rather the present invention allows the receiver 6 to have to be positioned only so that its main lobe comprises an area in which the receiver diaphragm 16 is present. Furthermore the present invention allows use as a receiver 6 of a receiver with a reception characteristic, in particular with a large aperture angle, which would otherwise not allow reliable measurement of the transmission of fluid 20 because the proportion of scattered received beam in relation to the non-scattered received beam is too large.

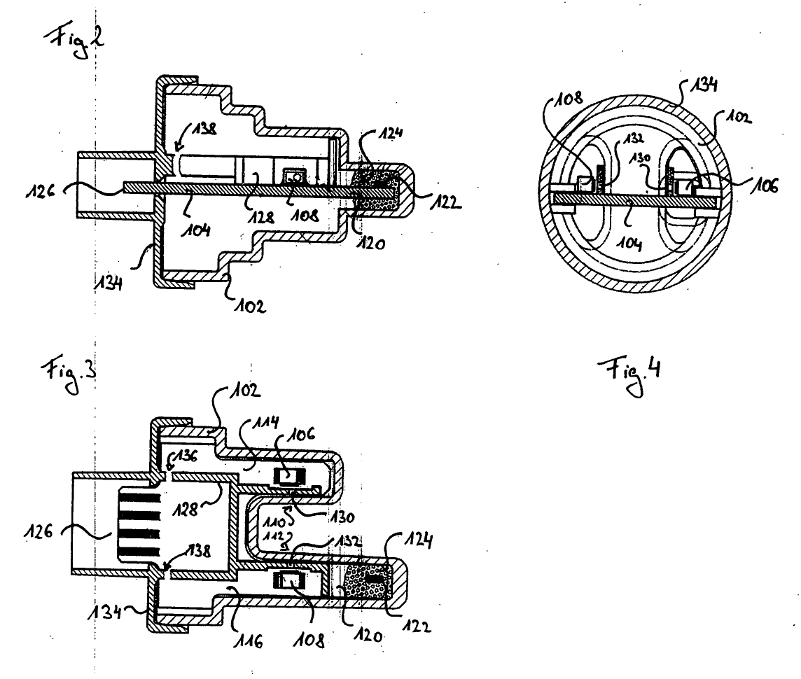

FIGS. 2, 3 and 4 show diagrammatically detailed depictions of a preferred embodiment of the sensor according to the invention. The sensor 100 comprises a housing 102 in which is arranged a carrier in the form of a circuit board 104. On the board is attached a transmitter 106 and a receiver 108.

The housing 102 at least in regions 110 and 112 is permeable to the beam of the wavelength generated by the transmitter 106. Advantageously the entire housing 102 is transparent and made of a uniform plastic. The circuit board 104 has a first leg 114 and a second leg 116. The transmitter 106 is attached to the first leg 114 and for energy supply and control is connected with corresponding tracks (not shown) of the circuit board 104. The receiver 108 is attached to the second leg 116 and also connected with tracks (not shown) of the board 104 for power supply and control.

The leg 116 is longer than the leg 114 and at its free end 120 has a temperature sensor 122 to detect the temperature of a fluid used in a washing machine or dishwasher. To improve the heat coupling of the temperature sensor 122 with a fluid surrounding the sensor 100, the temperature sensor 122 is embedded in a heat-conductive paste 124 which essentially completely fills the housing in the area of the free end 120 of the leg 116.

For connection with electrical connections for example of a washing machine or dishwasher, the circuit board 104 has a connection area 126 formed as a plug. The connection area 126 protrudes from the housing 102 in order to be plugged in a simple manner into a corresponding appliance connection.

Arranged on the circuit board 104 is a diaphragm arrangement 128. Advantageously the diaphragm system is arranged on the board 104 using catch, snap and/or plug connections. The diaphragm system 128 is arranged on the board 104 spaced from both the transmitter 106 and from the receiver 108. This applies in particular to a transmitter diaphragm 130 of the diaphragm system 128 which is arranged adjacent to but spaced from the transmitter 106. Also a receiver diaphragm 132 of the diaphragm system 128 is provided adjacent to but spaced from the receiver 108.

To seal the housing, in particular to prevent the penetration of fluid from the washing machine or dishwasher and other fluids, a cover 134 is attached to the housing 102. The cover 134 is secured to the housing 102 using snap and/or catch connections.

In the embodiment shown here the diaphragm system 128 and the cover 134 are shown as separate components. It is however proposed to provide the diaphragm system 128 and the cover 134 integrated in one constructional unit in the form of a single component. This is indicated in FIGS. 2 and 3 with the regions marked with reference numerals 136 and 138 which are closed for a one-piece design of the diaphragm system 128 and the cover 134.

In the above examples the transmitter diaphragm and receiver diaphragm are assumed to be substantially similar. In particular this applies to the diameter of the transmitter diaphragm and receiver diaphragm and the material thickness of the diaphragm system in the regions which form the transmitter diaphragm or receiver diaphragm.

The transmitter emits a transmitter beam. The transmitter diaphragm allows passage of only part of the transmitter beam, in particular an area within the main lobe of the transmitter beam, while the other parts of the transmitter beam, in particular the other areas of the main lobe, are screened. As a result the transmitter diaphragm generates a measurement beam of which the cross-section area in the region immediately after the transmitter diaphragm viewed in the propagation direction is clearly reduced in comparison with the cross-section area of the transmitter beam before the transmitter-diaphragm, also viewed in the propagation direction. On use of a circular transmitter diaphragm, the cross-section of the transmitter beam, in particular the cross-section of the main lobe of the transmitter beam, is reduced to a comparatively smaller cross-section of the measurement beam.

Preferably the transmitter diaphragm is formed so that the cross-section area of the measurement beam in the propagation direction from the transmitter diaphragm to the receiver remains substantially unchanged, and changes to the measurement beam are attributable substantially to changes in the beam power of the measurement beam on its propagation path because of the transmission properties of a fluid to be measured.

The receiver diaphragm generates a reception beam from the parts of the measurement beam which reach the receiver diaphragm after propagation through the fluid. If because of contamination of the fluid to be measured, (greater) scatter and reflection of the measurement beam occur on its propagation path through the fluid, it may be advantageous to use a receiver diaphragm whose dimensions, in particular diameter, are smaller than the dimensions or diameter of the transmitter diaphragm. As a result parts of the measurement beam which after scatter and/or reflection can reach the receiver through the receiver diaphragm are minimised because of the smaller receiver diaphragm. Such a receiver diaphragm can also be advantageous if, for example because of the design of the transmitter diaphragm, the measurement beam expands i.e. the measurement beam in the region of the transmitter diaphragm has a smaller cross-section area in the propagation direction than the cross-section area in the region of the receiver diaphragm.

The total beam power emitted by the transmitter in particular in the area of the main lobe of the transmitter beam can be selected depending on the desired beam power of the measurement beam after the transmitter diaphragm and/or in the region of the receiver diaphragm. The beam power of the transmitter can also be selected depending on the desired beam power of the reception beam i.e. parts of the measurement beam passing through the receiver diaphragm. Also the sensitivity of the receiver is a parameter to be taken into account in the design of the transmitter. Conversely it is also provided to design a sensor according to the invention by selecting a receiver with a reception characteristic suitable for the application concerned. The design of a sensor according to the invention can also be achieved by mutually dependent transmitter and receiver design.

Depending on the emission characteristic of the transmitter and/or the reception characteristic of the receiver, and depending on the application concerned in particular with regard to measurements to be performed by a sensor according to the invention, it is further proposed that the receiver diaphragm in comparison with the transmitter diaphragm is dimensioned larger, in particular has a larger diameter.

1-10. (canceled)

11. Sensor for transmission measurement in a washing machine or dishwasher with:
a carrier (2, 104),
a transmitter (4, 106) attached to the carrier (2, 104) to emit a transmitter beam (8),
a receiver (6, 108) attached to the carrier (2, 104) to receive the beam generated by the transmitter (4, 106), and
a diaphragm system (12, 128) arranged on the carrier (2, 104) spaced from the transmitter (4, 106), with a transmitter diaphragm (14, 130) arranged in the beam path of the transmitter beam in order to generate a measurement beam (18) aligned to the receiver (6, 108).

12. Sensor for transmission measurement in a washing machine or dishwasher with:
a carrier (2, 104),
a transmitter (4, 106) attached to the carrier (2, 104) to emit a transmitter beam (8),
a receiver (6, 108) attached to the carrier (2, 104) to receive the beam generated by the transmitter (4, 106), and
a diaphragm system (12, 128) arranged on the carrier (2, 104) spaced from the receiver (6, 108) with a receiver diaphragm (16, 132) arranged in the beam path of the transmitter beam (8) to generate a reception beam aligned to the receiver (6, 108).

13. Sensor for transmission measurement in a washing machine or dishwasher with:
a carrier (2, 104),
a transmitter (4, 106) attached to the carrier (2, 104) to emit a transmitter beam (8),
a receiver (6, 108) attached to the carrier (2, 104) to receive the beam generated by the transmitter (4, 106) and
a diaphragm system (12, 128) arranged on the carrier (2, 104) spaced from the transmitter (4, 106) and receiver (6, 108) with a transmitter diaphragm (14, 130) arranged in the beam path of the transmitter beam (8) to generate a measurement beam (18) and with a receiver diaphragm (16, 132) arranged in the beam path of the measurement beam (18) to generate a reception beam aligned to the receiver (6, 108).

14. Sensor according to claim 11 in which the carrier (2, 104) has a first leg (114) on which the transmitter (4, 106) is arranged and a second leg (116) on which the receiver (6, 108) is arranged opposite the transmitter (4, 106).

15. Sensor according to claim 11, in which the carrier (2, 104) comprises legs (114, 116) which are of different lengths and on the free end (120) of the longer leg (116) of the carrier (2, 104) is arranged a temperature sensor (122).

16. Sensor according to claim 11, in which the diaphragm system has a first diaphragm system leg which holds the transmitter diaphragm (14, 130).

17. Sensor according to claim 12 in which the carrier (2, 104) has a first leg (114) on which the transmitter (4, 106) is arranged and a second leg (116) on which the receiver (6, 108) is arranged opposite the transmitter (4, 106).

18. Sensor according to claim 12, in which the carrier (2, 104) comprises legs (114, 116) which are of different lengths and on the free end (120) of the longer leg (116) of the carrier (2, 104) is arranged a temperature sensor (122).

19. Sensor according to claim 12, in which the diaphragm system has a first diaphragm system leg which holds the transmitter diaphragm (14, 130).

20. Sensor according to claim 13 in which the carrier (2, 104) has a first leg (114) on which the transmitter (4, 106) is arranged and a second leg (116) on which the receiver (6, 108) is arranged opposite the transmitter (4, 106).

21. Sensor according to claim 13, in which the carrier (2, 104) comprises legs (114, 116) which are of different lengths and on the free end (120) of the longer leg (116) of the carrier (2, 104) is arranged a temperature sensor (122).

22. Sensor according to claim 13, in which the diaphragm system has a first diaphragm system leg which holds the transmitter diaphragm (14, 130).

23. Sensor according to claim 12, in which the diaphragm system has a second diaphragm system leg which holds the first receiver diaphragm (16, 132).

24. Method for production of a sensor to measure the transmission of a fluid in a washing machine or a dishwasher with the following steps:
provision of a carrier,
provision of a transmitter to emit a transmitter beam,
provision of a receiver to receive a reception beam,
provision of a diaphragm system with a transmitter diaphragm,
attachment of the transmitter and receiver on the carrier, and
arrangement of the diaphragm system on the carrier so that the diaphragm system is spaced from the transmitter and the transmitter diaphragm is arranged in the beam path of the transmitter beam in order to generate a measurement beam aligned to the receiver.

25. Method for production of a sensor to measure the transmission of a fluid in a washing machine or a dishwasher with the following steps:
provision of a carrier,
provision of a transmitter to emit a transmitter beam,
provision of a receiver to receive a reception beam,
provision of a diaphragm system with a receiver diaphragm,
attachment of the transmitter and receiver on the carrier, and
arrangement of the diaphragm system on the carrier so that the diaphragm system is spaced from the transmitter and the receiver diaphragm is arranged in the beam path of the transmitter beam in order to generate a reception beam aligned to the receiver.

26. Method for production of a sensor to measure the transmission of a fluid in a washing machine or a dishwasher with the following steps:
provision of a carrier,
provision of a transmitter to emit a transmitter beam,
provision of a receiver to receive a reception beam,
provision of a diaphragm system with a transmitter diaphragm and a receiver diaphragm,
attachment of the transmitter and receiver on the carrier, and
arrangement of the diaphragm system on the carrier so that the diaphragm system is spaced from the transmitter and the receiver, the transmitter diaphragm is arranged in the beam path of the transmitter beam in order to generate a measurement beam and the receiver diaphragm is arranged in the beam path of the measurement beam to generate a reception beam aligned to the receiver.
